(19) United States
(12) Patent Application Publication
(10) Pub. No.: US 2024/0075452 A1
(43) Pub. Date: Mar. 7, 2024

(54) SYSTEMS AND PROCESSES FOR REMOVAL OF CARBON DIOXIDE (CO2) FROM CO2-CONTAINING GASES USING ALKALI METAL ADSORBENTS

(71) Applicant: SUSTAERA INC., Durham, NC (US)

(72) Inventors: Tyson Lee LANIGAN-ATKINS, Durham, NC (US); Jian Ping SHEN, Chapel Hill, NC (US); Raghubir Prasad GUPTA, Durham, NC (US); Cory Elliott SANDERSON, Wendell, NC (US)

(21) Appl. No.: 18/383,562

(22) Filed: Oct. 25, 2023

Related U.S. Application Data
(63) Continuation of application No. PCT/US22/27466, filed on May 3, 2022.
(60) Provisional application No. 63/183,751, filed on May 4, 2021.

(51) Int. Cl. B01J 20/04; B01J 20/34

(52) U.S. Cl. CPC B01J 20/043; B01J 20/3483

(57) ABSTRACT

Processes are described for removal of CO₂ from a CO₂-containing gas comprising water vapor, including: (a) contacting the CO₂-containing gas comprising water vapor with an alkali metal carbonate adsorbent under conditions causing (i) the water vapor in the CO₂-containing gas comprising water vapor to react with the alkali metal carbonate to form a corresponding alkali metal carbonate hydrate, and (ii) the corresponding alkali metal carbonate hydrate to react with CO₂ in the CO₂-containing gas comprising water vapor to form a corresponding alkali metal sesquicarbonate; and (b) reacting the alkali metal sesquicarbonate under conditions effective to recover CO₂ and to regenerate alkali metal carbonate hydrate adsorbent therefrom. Systems for carrying out such process are also described, which are applicable to direct air capture (DAC) of CO₂, as well as to treatment of CO₂-containing flue gases from power plants and other oxidation and combustion sources.

### CROSS-REFERENCE TO RELATED APPLICATIONS

This application is a continuation application of PCT Application No. PCT/US22/27466, filed on May 3, 2022, which claims priority to U.S. Provisional Patent Application No. 63/183,751, filed on May 4, 2021, the entire contents of all of which are incorporated by reference in their entirety herein.

### STATEMENT OF FEDERALLY FUNDED RESEARCH

This invention was made with United States Government support under contract numbers DE-SC0020795 and DE-FE0032118 awarded by the U.S. Department of Energy. The United States Government has certain rights in the invention.

### BACKGROUND

### Field of the Disclosure

The present disclosure relates to systems and processes for removing carbon dioxide (CO₂) from CO₂-containing gases, utilizing alkali metal adsorbents. In various specific applications of the disclosure, alkali metal adsorbents are used for direct air capture (DAC) of CO₂ from ambient air, and in other specific applications, CO₂ is removed from CO₂-containing effluent gases such as flue gases from power plants, hydrocarbon processing refineries, and other industrial CO₂ effluent-generating facilities.

### Description of the Related Art

Carbon dioxide is a major greenhouse gas in the Earth's atmosphere that has consistently increased in the atmosphere in the Anthropocene era, from preindustrial concentrations on the order of 280 ppm by volume to the current atmospheric concentrations exceeding 400 ppm by volume. The generative causes and pernicious effects of such increasing levels of atmospheric carbon dioxide are well recognized, as including mediation of climatological increases in temperature, as well as progressive acidification of the planet's surface and subsurface waters, with consequent adverse effects on marine and freshwater lifeforms and habitat. Since carbon dioxide has a long atmospheric lifetime of hundreds to thousands of years, ambient carbon dioxide has become a focus of substantial concern and has intensified efforts to restrict CO₂ concentrations from increasing, by implementation of CO₂ abatement and sequestration technologies, and reduction, elimination, and replacement of existing sources of CO₂ emissions.

The current methods of removing CO₂ from air primarily utilize amine-based adsorbents where CO₂ present in air is chemically reacted with amine to form amine-CO₂ products like bicarbonate or carbamate. Once saturated with CO₂, the sorbent is generally regenerated with steam to desorb CO₂ by heating to temperatures around 100° C. and higher. Once regenerated, the sorbent is cooled for the subsequent cycle for adsorbing CO₂ and this process continues for hundreds of cycles. Some commercial amine sorbents utilize amines that are supported on high surface area supports such as silica, alumina, and metal organic frameworks (MOFs) to provide high rate in the successive cyclic adsorption and desorption reactions. Amine sorbents of such type are currently being commercially utilized in direct air capture (DAC) processes, such as those available from Climeworks AG (Zürich, Switzerland) and Global Thermostat, LLC (New York, NY).

The amine sorbents supported on high surface area materials, as developed to date, are generally expensive. Additionally, there is currently no manufacturing infrastructure for large-scale production of these types of sorbents at volumes needed to make them practical for gigaton-level removal of CO₂. Further, these sorbents undergo rapid deactivation in the presence of oxygen in the ambient air environment, and the support materials typically employed have the deficiency that they capture moisture from the ambient air, which in turn impedes the adsorption of CO₂ from air by the supported amine sorbent.

In this context, there is a compelling need for sorbent materials that (1) can effectively capture CO₂ from air at ambient conditions in the presence of moisture, (2) can be regenerated with reasonable desorption energy requirements, (3) can operate effectively for 3-5 years of continuous adsorption-regeneration cycles, (4) are relatively inexpensive, (5) are abundantly available to address gigaton/year CO₂ removal requirements, (6) can be readily implemented in process systems using existing manufacturing infrastructure, and (7) are environmentally benign.

There is correspondingly a compelling need for capture of CO₂ from gases that are produced by a wide variety of CO₂-generating sources such as power generation plants, hydrocarbon processing facilities, combustion engines, heating, and cooling equipment, etc.

### SUMMARY

The present disclosure relates to carbon dioxide (CO₂) removal systems and processes, in which alkali metal carbonate adsorbent is utilized as an active CO₂ removal agent.

In one aspect, the disclosure relates to a process for removal of CO₂ from a CO₂-containing gas comprising water vapor, the process comprising (a) contacting the CO₂-containing gas comprising water vapor with an alkali metal carbonate adsorbent under conditions causing (i) the water vapor in the CO₂-containing gas comprising water vapor to react with the alkali metal carbonate to form a corresponding alkali metal carbonate hydrate, and (ii) the corresponding alkali metal carbonate hydrate to react with CO₂ in the CO₂-containing gas comprising water vapor to form a corresponding alkali metal carbonate/bicarbonate compound; and (b) reacting the alkali metal carbonate/bicarbonate compound under conditions effective to recover CO₂ and to regenerate alkali metal carbonate hydrate adsorbent therefrom.

In another aspect, the disclosure relates to a system for removal of CO₂ from a CO₂-containing gas comprising water vapor, the system comprising: a reactor; a source of CO₂-containing gas comprising water vapor, arranged in feed relationship to the reactor; an alkali metal carbonate adsorbent in the reactor; a regeneration assembly arranged to selectively regenerate the alkali metal carbonate adsorbent after CO₂-removal reactions of the alkali metal carbonate adsorbent; and a control assembly arranged to operate the reactor in an operation comprising (a) contacting the CO₂-containing gas comprising water vapor with the alkali metal carbonate adsorbent under conditions causing (i) the water vapor in the CO₂-containing gas comprising water vapor to react with the alkali metal carbonate to form a corresponding alkali metal carbonate hydrate, and (ii) the corresponding alkali metal carbonate hydrate to react with CO₂ in the CO₂-containing gas comprising water vapor to form a corresponding alkali metal sesquicarbonate; and (b) reacting the alkali metal sesquicarbonate under conditions effective to recover CO₂ and to regenerate alkali metal carbonate hydrate adsorbent therefrom, wherein the control assembly actuates the regeneration assembly for such regeneration according to a predetermined operational condition.

Other objects, features, advantages, and embodiments of the disclosure will be more fully apparent from the ensuing description and appended claims.

### BRIEF DESCRIPTION OF THE DRAWINGS

FIG. 1 is a graph showing how the total CO₂ pickup per mass of sorbent sample during the adsorption phase varies depending upon the relative humidity (at ˜22° C.) and partial pressure ratio of the air in association with the exemplary embodiment in Example 1. The arrows indicate the chronology of the cycles going from oldest to most recent.

FIG. 2 is a series of XRD scans in association with the exemplary embodiment in Example 2. The decomposition of NaHCO₃ was investigated by performing in-situ x-ray diffraction (XRD) measurements as the sample was heated under low nitrogen flow. The measured data are compared to reference data for NaHCO₃ and Na₂CO₃. The curves are offset for clarity.

FIG. 3 is a chart showing the effluent CO₂ concentration as well as cumulative CO₂ desorption as a function of time in association with the exemplary embodiment in Example 2. The amount of CO₂ desorbed during the in-situ XRD described in FIG. 2 was monitored with gas analyzers to generate the data in FIG. 3. The curve for CO₂ concentration in the effluent is plotted with select temperatures highlighted on the left y-axis, while the curve for cumulative CO₂ desorbed as a function of time is plotted on the right y-axis.

FIG. 4 is a series of XRD scans in association with the exemplary embodiment in Example 2. The decomposition of NaHCO₃ was investigated by performing in-situ x-ray diffraction (XRD) measurements as the sample was heated under low nitrogen flow. The figure shows the data at 25° C. prior to heating and after heating to 200° C. and cooling back to 25° C. The measured data are compared to reference data for NaHCO₃ and Na₂CO₃.

FIG. 5 is a series of XRD scans in association with the exemplary embodiment in Example 2. In-situ XRD was performed as humidified 400 ppmv CO₂ was flowed through the sample. Patterns collected at the start (10 minutes) and end (1330 minutes) of adsorption are included. The in-situ measurements are compared with a reference pattern for Na₂CO₃ and a scan for Na₂CO₃·H₂O which was measured under the same experimental conditions as the in-situ scans.

FIG. 6 is a chart showing cumulative CO₂ adsorption for samples in association with the exemplary embodiment in Example 3. Equivalent samples of Na₂CO₃ dispersed on alumina were tested, which were subjected to different adsorption times during the second cycle.

FIG. 7 is a series of XRD scans in association with the exemplary embodiment in Example 3. The samples from FIG. 6, which underwent different adsorption times, were probed with X-ray diffraction. The collected patterns are shown and compared with a measured pattern of pure trona. The curve labeled “d) Difference” corresponds to the difference between the c) 133 minutes and a) 6 minutes adsorption curves. The dashed horizontal line corresponds to the zero for curve d). Positive data (relative to the zero line) correspond to peaks which emerge after long (133 minutes) adsorption times.

FIG. 8 is a series of XRD scans in association with the exemplary embodiment in Example 3. In-situ x-ray diffraction (XRD) measurements were taken as the sample that had undergone long (133 minutes) adsorption was heated under low nitrogen flow. The figure shows the data at 25° C. prior to heating, at various temperatures during heating to 200° C. and after cooling back to 25° C.

FIG. 9 is a series of XRD scans in association with the exemplary embodiment in Example 3. This figure compares the XRD intensity difference (data measured at 25° C. before and after heating) curve in FIG. 8 with measured trona and Na₂CO₃ patterns.

FIG. 10 is a series of XRD scans in association with the exemplary embodiment in Example 4. The decomposition of KHCO₃ was investigated by performing in-situ x-ray diffraction (XRD) measurements as the sample was heated under low nitrogen flow. The figure shows the data at 25° C. prior to heating, during heating to 200° C. and after cooling back to 25° C. The measured data are compared to reference data for KHCO₃ and K₂CO₃.

FIG. 11 is a series of XRD scans in association with the exemplary embodiment in Example 4. In-situ XRD was performed as humidified 400 ppmv CO₂ flowed through the sample. Patterns collected at the start (10 minutes) and after 170 minutes of adsorption are included. The in-situ measurements are compared with a reference pattern for K₂CO₃ and a scan for K₂CO₃·1.5H₂O which was measured in the same experimental conditions.

FIG. 12 is a chart showing a detailed phase diagram of reaction pathways of the sodium carbonate/bicarbonate/sesquicarbonate system, in which CO₂ partial pressure, in atmospheres, is plotted as a function of temperature, in ° C.

FIG. 13 is a graph of average annual partial pressure ratio p_{H2O}/p_{CO2}, of atmospheric moisture partial pressure p_{H2O} to atmospheric CO₂ partial pressure p_{CO2}, in the same units of measurement, as a function of temperature, for various states of the United States, including Alaska, North Carolina, and Florida.

FIG. 14 is a graph of average annual partial pressure ratio p_{H2O}/pco₂, of atmospheric moisture partial pressure p_{H2O} to atmospheric CO₂ partial pressure p_{CO2}, in the same units of measurement, as a function of as a function of relative humidity (%), for various states of the United States, including Arizona, North Carolina, and Louisiana.

FIG. 15 is a schematic representation of a process system including cyclically operated adsorbent vessels in which CO₂ is removed from ambient air using alkali metal adsorbent and desorbed with electricity and vacuum, according to one embodiment of the present disclosure.

FIG. 16 is a schematic representation of a process system in which waste heat from an electricity-generating power plant is utilized in removing CO₂ from flue gas and from ambient air to produce synergistically captured CO₂, in accordance with another embodiment of the present disclosure.

FIG. 17 is a schematic representation of a process system including cyclically operated adsorbent vessels in which CO₂ is removed from ambient air, as well as from other CO₂-containing gas, using alkali metal adsorbent and desorbed with electricity and steam, according to a further embodiment of the present disclosure.

### DETAILED DESCRIPTION

The present disclosure relates to CO₂-removal systems and processes, and to the use of alkali metal adsorbents for removal of CO₂ from CO₂-containing gas. In various embodiments, the disclosure relates to direct air capture of CO₂ from air. In other embodiments, the disclosure relates to capture of CO₂ from CO₂-containing gas such as effluents from oxidation and combustion processes and facilities.

The present disclosure contemplates the use of alkali metal adsorbents as reactive agents for capturing CO₂ from gases containing same, using a novel adsorption-desorption cycle.

In the ensuing description, the terms “desorption” and “regeneration” are used interchangeably to mean removal of previously absorbed CO₂ from the adsorbent to renew the adsorbent for subsequent CO₂-removal use.

As used herein, the term “alkali metal” refers to any one or more of lithium (Li), sodium (Na), potassium (K), rubidium (Rb), cesium (Cs), and francium (Fr).

As used herein, the singular forms “a”, “and”, and “the” include plural referents unless the context clearly dictates otherwise.

The disclosure, as variously set out herein in respect of features, aspects, and embodiments thereof, may in particular implementations be constituted as comprising, consisting, or consisting essentially of, some or all of such features, aspects and embodiments, as well as elements and components thereof being aggregated to constitute various further implementations of the disclosure. The disclosure is set out herein in various embodiments, and with reference to various features and aspects of the disclosure. The disclosure contemplates such features, aspects and embodiments in various permutations and combinations, as being within the scope of the invention. The disclosure may therefore be specified as comprising, consisting, or consisting essentially of any of such combinations and permutations of these specific features, aspects and embodiments, or a selected one or ones thereof.

The CO₂ adsorbents of the present disclosure comprise alkali metal carbonates. Although the description herein is primarily directed to sodium carbonates, the disclosure is not limited thereto, and encompasses other alkali metal carbonates in the broad practice of the present disclosure. Exemplary alkali metal carbonates include lithium (Li) carbonates, sodium (Na) carbonates, potassium (K) carbonates, and cesium (Cs) carbonates. Sodium (Na) carbonates and potassium (K) carbonates are particularly preferred. Sodium (Na) carbonates are most preferred and are hereafter illustratively described in various embodiments of the disclosure. The disclosure also contemplates the use of multiple different alkali metal carbonates in combination with one another for capture of CO₂ from CO₂-containing gas, e.g., a mixture of sodium carbonate and potassium carbonate.

Use of sodium carbonate for removal of CO₂ according to the reaction (1)

Na₂CO₃(s)+H₂O(g)+CO₂(g)=2NaHCO₃(s) (1)

is known in the art. The heat of this reaction (1) is about −135.5 kJ/mole of CO₂ at 25° C. It is to be noted that for this reaction, equimolar amounts of moisture and CO₂ are required. For higher moisture to CO₂ concentrations, as found in air, CO₂ adsorption on alkali carbonate sorbents does not follow the reaction pathway as shown in reaction (1).

For capture of CO₂ from air, where the concentration of CO₂ in air is on the order of 415 ppm by volume, and the water content is illustratively assumed to be 2% by volume, reaction (1) will result in adsorption of CO₂ at temperature up to 50° C. Heating the sorbent higher than a temperature of 50° C. will then reverse the reaction, resulting in desorption of CO₂. However, energy must be supplied for the endothermic heat of reaction in order for CO₂ to desorb. If CO₂ desorption follows the reaction (2)

2NaHCO₃(s)=Na₂CO₃(s)+H₂O(g)+CO₂(g) (2)

then the reaction will require 135.5 kJ/mole of CO₂ for regeneration, which is about 60%-80% higher than amine-based sorbents, which typically require 75-85 kJ/mole of CO₂ for regeneration. Accordingly, the regeneration of the sodium bicarbonate product of reaction (1) by regeneration reaction (2) will result in a high energy cost per ton of CO₂ removed from air.

The present disclosure overcomes such deficiency by the innovative approach of utilizing a two-step reaction pathway to address the concentration difference between CO₂ and H₂O in the ambient air efficiently and effectively. Typically, the H₂O concentration in air is on the order of about 10-50 times that of CO₂ on a molar/volume basis, depending on the relative humidity of the air. Under such conditions, the sodium bicarbonate formation pathway of reaction (1) described above, utilizing equimolar amounts of CO₂ and H₂O vapor, is not the thermodynamically preferred pathway for CO₂ capture. Rather, it was determined that H₂O vapor present in ambient air first reacts with Na₂CO₃ to form sodium carbonate hydrate according to the reaction (3)

Na₂CO₃(s)+H₂O(g)=Na₂CO₃(s)·H₂O(s) (3).

The enthalpy change (ΔH) and the Gibbs free energy change (ΔG) of this reaction (3) are −57.4 kJ/mole and −11 kJ/mole, respectively, at ambient conditions (25° C., 1 atmospheric pressure). These values indicate that reaction (3) is thermodynamically favorable relative to reaction (1), and that the hydration reaction is exothermic and results in heat release.

The above sodium carbonate hydrate product of reaction (3) subsequently reacts with CO₂ present in air according to the reaction (4)

3Na₂CO₃·H₂O(s)+CO₂(g)+2H₂O(g)↔2Na₂CO₃·NaHCO₃·2H₂O(s) (4)

to form the corresponding alkali metal sesquicarbonate dihydrate.

The compound Na₂CO₃·NaHCO₃·2H₂O produced by reaction (4) is known as sodium sesquicarbonate dihydrate or Trona (manufactured by Solvay, CAS No. 533-96-0).

Depending on temperature and other conditions like reaction time, the sodium carbonate hydrate product of reaction (3) can also subsequently react with CO₂ present in air according to the reaction (5) to eventually form sodium bicarbonate through several intermediate reaction pathways.

Na₂CO₃(s)·H₂O(s)+CO₂(g)↔2NaHCO₃ (5).

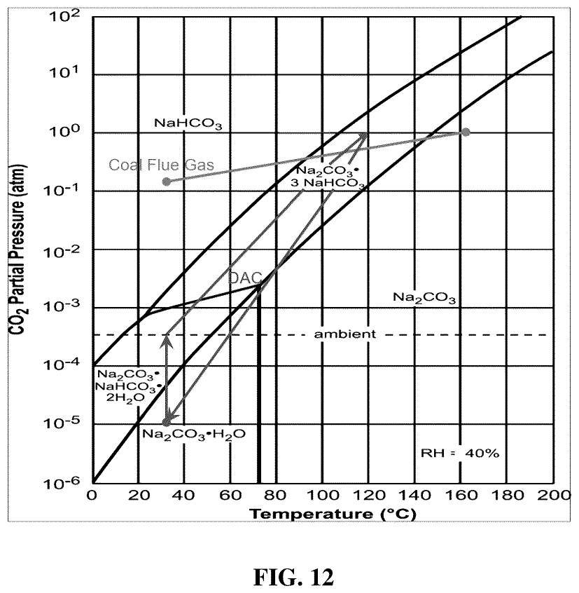

FIG. 12 shows a detailed phase diagram of reaction pathways of the sodium carbonate/bicarbonate/sesquicarbonate system, in which CO₂ partial pressure, in atmospheres, is plotted as a function of temperature, in ° C.

As discussed hereinabove, use of sodium carbonate for removal of CO₂ according to the reaction (1)

Na₂CO₃(s)+H₂O(g)+CO₂(g)=2NaHCO₃(s) (1)

is known in the art, e.g., for removal of CO₂ from coal flue gas. This reaction is reflected in the phase diagram of FIG. 12 (“Coal Flue Gas”). A typical CO₂ concentration in the flue gas from a coal fired plant is 13-14 vol % and therefore the reaction follows the sodium carbonate/sodium bicarbonate pathway. The decomposition energy for this reaction (1) is 135.5 kJ/mole of CO₂. However, for lower concentrations of CO₂ as found in ambient air, as shown in FIG. 12, the reaction pathway follows the sodium carbonate monohydrate/sodium sesquicarbonate reaction pathway (“DAC”). This pathway enables the achievement of an overall energy for regeneration as low as 40 kJ/mole of CO₂.

As will be described in greater detail hereinbelow, a combination of low concentration of CO₂ and relatively high moisture content (due to humidity) in the ambient air can be utilized to exploit the sodium carbonate hydrate/sodium sesquicarbonate reaction pathway to carry out reactions (3) and (4) for capture of CO₂ from air using a sodium carbonate adsorbent.

The inventors have experimentally validated this pathway. In Example 1 of this disclosure, the effect of moisture content in air was investigated to determine the CO₂ capture capacity of an exemplary sodium carbonate sorbent. The adsorption capacity of the sorbent was increased when relative humidity was from about 20% to about 100%. Conversion of the relative humidity percentages to partial pressure H₂O/partial pressure CO₂ can be seen in Table 1.

In Example 2, NaHCO₃ decomposition to Na₂CO₃ was analyzed and evaluated at varying temperatures. Testing showed that the exemplary sample decomposed from an initial composition of NaHCO₃ to a final composition of Na₂CO₃ as temperature increased from 25° C. to 200° C. Testing in Example 2 additionally analyzed CO₂ desorption for an exemplary embodiment of a sodium carbonate sorbent across a temperature range of 25 to 200° C. The evaluation showed that most CO₂ desorption occurred between 80-150° C., which corresponds with the temperatures at which relatively large changes in the XRD patterns of NaHCO₃ powder samples took place. Moreover, in Example 2, adsorption was performed for an air sample having a relative humidity of 75% at room temperature using the same adsorbent sample that had been heated to decompose NaHCO₃ into Na₂CO₃. The testing and analysis showed that the Na₂CO₃ adsorbent firstly converted to Na₂CO₃·H₂O which subsequently converted into trona (sodium sesquicarbonate dihydrate).

In Example 3, exemplary samples comprising Na₂CO₃ dispersed on alumina were pre-treated and run through a first adsorption and desorption cycle. The samples were run through a second adsorption step with varying adsorption times. XRD measurements of the samples for which adsorption times varied showed that during CO₂ adsorption using a sodium carbonate sorbent, sodium sesquicarbonate dihydrate (Na₂CO₃·NaHCO₃·2H₂O) or Trona was formed during adsorption. Subsequent heating of the measured sodium sesquicarbonate dihydrate for desorption showed the transition back to Na₂CO₃ around 60° C. This is significantly below the known decomposition temperature of Trona reported in the literature (about 120° C.) in its pure component form.

In Example 4, KHCO₃ decomposition to K₂CO₃ was analyzed and evaluated at varying temperatures. Testing showed that the exemplary sample decomposed from an initial composition of KHCO₃ to a final composition of K₂CO₃ as temperature increased from 25° C. to 200° C. Moreover, in Example 4, adsorption was performed for an air sample having a relative humidity of 75% at room temperature using the same adsorbent sample that had been heated to decompose KHCO₃ into K₂CO₃. The testing and analysis showed that the K₂CO₃ adsorbent firstly converted to K₂CO₃·1.5H₂O in the presence of humid air.

A process for removal of CO₂ from a CO₂-containing gas comprising water vapor is described herein. The process comprises: (a) contacting the CO₂-containing gas comprising water vapor with an alkali metal carbonate adsorbent under conditions causing (i) the water vapor in the CO₂-containing gas comprising water vapor to react with the alkali metal carbonate to form a corresponding alkali metal carbonate hydrate, and (ii) the corresponding alkali metal carbonate hydrate to react with CO₂ in the CO₂-containing gas comprising water vapor to form a corresponding alkali metal sesquicarbonate; and (b) reacting the alkali metal sesquicarbonate under conditions effective to recover CO₂ and to regenerate alkali metal carbonate hydrate adsorbent therefrom.

In the CO₂ adsorption reaction process, wherein the partial pressure of CO₂ is p_{CO2} and the moisture partial pressure is p_{H2O}, in the same units of partial pressure, in embodiments, the ratio p_{H2O}/p_{CO2} can be at least 5, or at least 10, and up to 100, or more, depending on the temperature and relative humidity of the CO₂-containing gas being processed, although the disclosure is not thus limited. In the case of direct air capture of CO₂, the ratio p_{H2O}/p_{CO2} is desirably in a range of from 10 to 70, depending on the temperature and relative humidity of inlet air being processed in the CO₂ capture system, but again, the disclosure is not limited thereto.

Accordingly, in various embodiments of such process, in the CO₂-containing gas comprising water vapor, the ratio p_{H2O}/p_{CO2}, of the partial pressure of CO₂, p_{CO2}, to the partial pressure of water vapor, p_{H2O}, in corresponding units of partial pressure, may be in a range of from 5 to 100, or more. In other embodiments of such process, in the CO₂-containing gas comprising water vapor, the ratio p_{H2O}/p_{CO2}, of the partial pressure of CO₂, p_{CO2}, to the partial pressure of water vapor, p_{H2O}, in corresponding units of partial pressure, may be in a range of from 5 to 70, or from 10 to 60, or from 10 to 50, or in any other suitable range that is effective for a desired capture of CO₂ from a CO₂-containing gas.

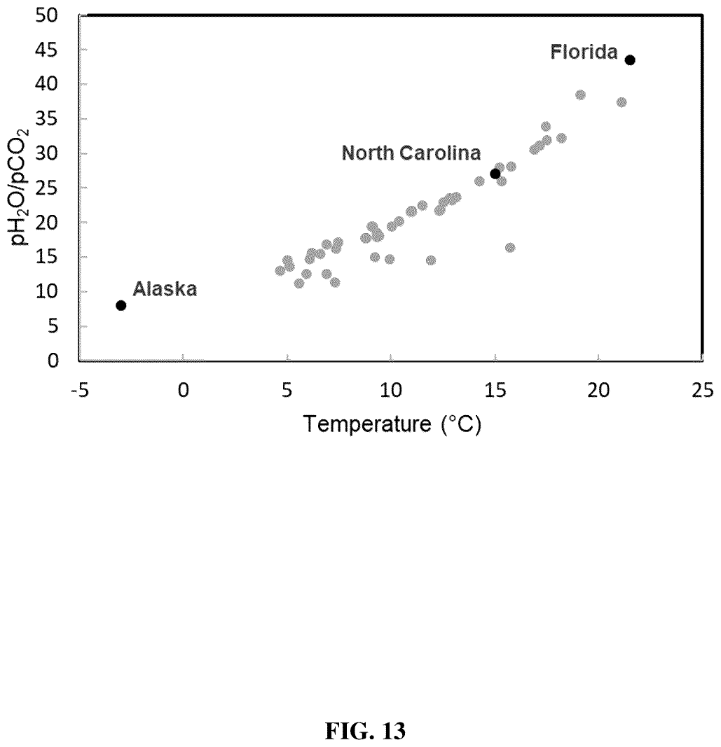

FIG. 13 is a graph of average annual partial pressure ratio p_{H2O}/pco₂, of atmospheric moisture partial pressure p_{H2O} to atmospheric CO₂ partial pressure p_{CO2}, in the same units of measurement, as a function of temperature, for various states of the United States, including Alaska, North Carolina, and Florida. The data in FIG. 13 show that the partial pressure ratio p_{H2O}/p_{CO2} ranges from levels on the order of about 7.5 in Alaska for temperature on the order of −3° C., to levels on the order of about 43 in Florida for temperature on the order of 22° C.

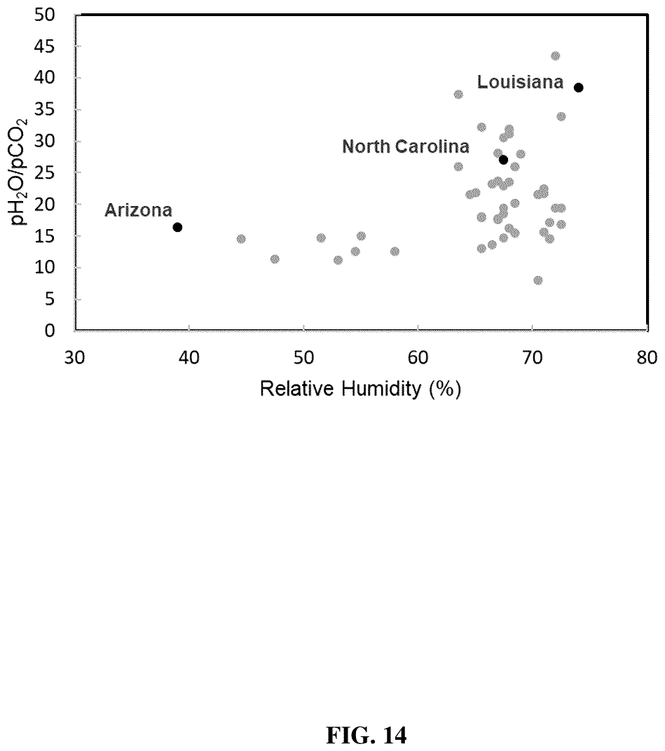

FIG. 14 is a graph of average annual partial pressure ratio p_{H2O}/pco₂, of atmospheric moisture partial pressure p_{H2O} to atmospheric CO₂ partial pressure p_{CO2}, in the same units of measurement, as a function of as a function of relative humidity (%), for various states of the United States, including Arizona, North Carolina, and Louisiana. The data in FIG. 14 show that the partial pressure ratio p_{H2O}/p_{CO2} ranges from levels on the order of about 7.5 for relative humidity on the order of about 7.5%, to levels on the order of about 43% for relative humidity on the order of 72%.

In various embodiments of the processes of the present disclosure, in the CO₂-containing gas comprising water vapor, the ratio p_{H2O}/p_{CO2}, of the partial pressure of water vapor, p_{H2O}, to the partial pressure of CO₂, p_{CO2}, in corresponding units of partial pressure, may be in a range wherein a lower end point of the ratio p_{H2O}/p_{CO2} is any one of 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, and 95, and wherein an upper end point of the ratio p_{H2O}/p_{CO2} is 100, or more.

The process as variously described above may be conducted in various embodiments, wherein, in the CO₂-containing gas comprising water vapor, the ratio p_{H2O}/p_{CO2}, of the partial pressure of water vapor, p_{H2O}, to the partial pressure of CO₂, p_{CO2}, in corresponding units of partial pressure, is in a range in which the lower end point of the range is any one of 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, and 95, and in which the upper end point of the range is greater than the lower end point of the range, and is any one of 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95 and 100, or more.

The process as variously described above may be conducted in various other embodiments, wherein, in the CO₂-containing gas comprising water vapor, the ratio p_{H2O}/p_{CO2}, of the partial pressure of water vapor, p_{H2O}, to the partial pressure of CO₂, p_{CO2}, in corresponding units of partial pressure, is in a range in which the lower end point of the range is any one of 5, 10, 15, 20, 25, 30, 35, 40, and 45, and in which the upper end point of the range is greater than the lower end point of the range, and is any one of 10, 15, 20, 25, 30, 35, 40, 45, 50, 60, 65, and 70.

In the process of the present disclosure, the CO₂-containing gas comprising water vapor may have a relative humidity in a range of from 0.5% to 100%, although the present disclosure is not limited thereto, and any other suitable relative humidity levels may be employed in various implementations of the disclosure. For example, the CO₂-containing gas comprising water vapor may have a relative humidity in a range in which the lower end point of the range is any one of 0.5%, 1%, 1.5%, 2.0%, 2.5%, 5%, 10%, 15%, 20%, 25%, 30%, 35%, 40%, 45%, 50%, 55%, 60%, 65%, 70%, 75%, 80%, 85%, and 90% and in which the upper end point of the range is 100%. As another example, the CO₂-containing gas comprising water vapor may have a relative humidity in a range in which the lower end point of the range is any one of 0.5%, 1%, 1.5%, 2.0%, 2.5%, 5%, 10%, 15%, 20%, 25%, 30%, 35%, 40%, 45%, 50%, 55%, 60%, 65%, 70%, 75%, 80%, 85%, and 90%, and in which the upper end point of the range is greater than the lower end point of the range, and is any one of 5%, 10%, 15%, 20%, 25%, 30%, 35%, 40%, 45%, 50%, 55%, 60%, 65%, 70%, 75%, 80%, 85%, 90%, 95%, and 100%.

The process of the present disclosure may be conducted for direct air capture of CO₂. Thus, the disclosure contemplates various embodiments in which the CO₂-containing gas comprising water vapor is atmospheric air at ambient temperature.

The CO₂-containing gas comprising water vapor may be of any suitable composition, and may in various embodiments comprise one or more of nitrogen, oxygen, argon, neon, krypton, helium, hydrogen, methane, ethane, propane, butane, ethylene, acetylene, carbon monoxide, nitrogen oxide, and hydrogen sulfide, although the disclosure is not limited thereto, and any suitable CO₂-containing gas compositions may be processed for CO₂ removal in accordance with the present disclosure.

In various embodiments, the conditions in the contacting (a) may comprise temperature in a range of from 5° C. to 40° C., although the disclosure is not limited thereto. In these or other embodiments, the conditions in the reacting (b) may comprise temperature in a range of from 45° C. to 160° C., or higher, although the disclosure is not limited thereto. In various other embodiments, the contacting (a) may be carried out at temperature in a range of from 5° C. to 35° C., and the reacting (B) may be carried out at temperature in a range of from 80° C. to 160° C., although the disclosure is not limited thereto.

It will be correspondingly appreciated that the process of the present disclosure may be conducted under any of a variety of suitable process conditions, including temperatures, pressures, flowrates, and/or compositions, in specific implementations of the processes and systems herein disclosed.

The process of the present disclosure may be carried out with any suitable alkali metal carbonate adsorbent, e.g., an alkali metal carbonate adsorbent comprising at least one of sodium carbonate, potassium carbonate, lithium carbonate, and cesium carbonate. The process in specific embodiments may employ sodium carbonate as the alkali metal carbonate adsorbent, as for example in processes conducted for direct air capture of CO₂.

In specific embodiments, the process of the present disclosure may be carried out, wherein the initial reaction of the water vapor in the CO₂-containing gas comprising water vapor with the alkali metal carbonate to form the corresponding alkali metal carbonate hydrate in the contacting (a) comprises reaction (3) to form the CO₂ sorbent:

Na₂CO₃(s)+H₂O(g)=Na₂CO₃(s)·H₂O(s) (3).

The process may additionally or independently be carried out, wherein the reaction of the corresponding alkali metal carbonate hydrate “CO₂ sorbent” with CO₂ to form the corresponding alkali metal sesquicarbonate in the contacting (a) comprises reaction (4) in the forward direction, and regeneration (b) in the reverse direction:

3Na₂CO₃·H₂O(s)+CO₂(g)+2H₂O(g)↔2Na₂CO₃·NaHCO₃·2H₂O(s) (4)

In another specific embodiment utilizing potassium carbonate, the process of the present disclosure may be carried out in which the water vapor in the CO₂-containing gas is initially reacted with potassium carbonate to form the corresponding potassium carbonate hydrate in the contacting (a), comprising reaction (6) to form the CO₂ sorbent:

K₂CO₃(s)+1.5H₂O(g)=K₂CO₃(s)·1.5H₂O(s) (6).

The process may additionally or independently be carried out wherein the reaction of the corresponding potassium carbonate hydrate “CO₂ sorbent” with CO₂ to form the corresponding potassium sesquicarbonate in the contacting (a), comprises reaction (7) in the forward direction, and regeneration (b) in the reverse direction:

2K₂CO₃·1.5H₂O(s)+CO₂(g)↔K₂CO₃·2KHCO₃·1.5H₂O(s)+0.5H₂O(g) (7).

In the case of temperature variation, the hydrate of potassium carbonate product of reaction (6) can also subsequently react with CO₂ present in air according to the reaction (8):

K₂CO₃·1.5H₂O(s)+CO₂(g)↔2KHCO₃+0.5H₂O(g) (8).

The enthalpy change (ΔH) of the reaction (8) is −40 kJ/mole at ambient conditions (25° C., 1 atmospheric pressure). The potassium bicarbonate formed by reaction (8) can be advantageously regenerated into potassium carbonate hydrate by reversing the reaction (8) in a temperature range of 80° C.-150° C. with a heat input of −40 kJ/mole of CO₂.

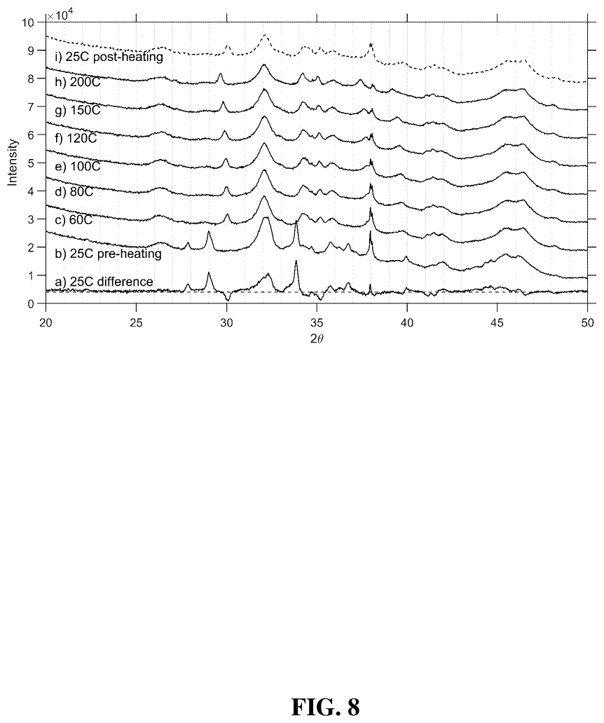

The process of the present disclosure may be carried out with the alkali metal carbonate adsorbent being in any suitable sorbent form. For example, the alkali metal carbonate adsorbent may be in a particulate form, or supported on a support, such as a support comprising silica, alumina, aluminosilicate, graphite, vitreous carbon, graphene, silicon carbide, metal organic framework, macroreticulate polymer, or any other suitable support material or article. Advantageously, as discussed, and shown in Example 3 and accompanying FIG. 8, it has been found that suitable support of the alkali metal carbonate sorbent enables reduction in the reaction temperature for desorption or regeneration. In various embodiments, the support may comprise a monolith, and the alkali metal carbonate adsorbent may be coated on the monolith. In other embodiments, the alkali metal carbonate adsorbent may be provided in a laminate. The laminate may for example comprise a heating layer that is selectively heatable to recover CO₂ and to regenerate the alkali metal carbonate adsorbent therefrom, e.g., an electrically resistive material that is selectively heatable by application of electrical energy thereto.

More generally, the process may be carried out, in which the alkali metal sesquicarbonate (and alkali metal bicarbonate, if present) is reacted by heating thereof to recover CO₂ and to regenerate alkali metal carbonate hydrate adsorbent therefrom, with the heating being carried out by any suitable heating modalities, such as for example steam contacting, hot CO₂ contacting, heating fluid, or electrical heating. In the regeneration operation, the alkali metal sesquicarbonate may be reacted under vacuum conditions to recover CO₂ and to regenerate alkali metal carbonate hydrate adsorbent therefrom. Accordingly, in various embodiments, the alkali metal carbonate adsorbent may be regenerated from the alkali metal sesquicarbonate (and alkali metal bicarbonate, if present) by heating of the alkali metal sesquicarbonate (and alkali metal bicarbonate, if present) under vacuum conditions, or in any other suitable manner appropriate to such CO₂ recovery and regeneration operation.

In another preferred embodiment, the alkali metal carbonate sorbent may be pre-hydrated by passing a moisture-laden gas stream under conditions sufficient to convert at least 50% of the alkali metal carbonate into a suitable hydrate of the alkali metal carbonate. Such hydrate of the alkali metal carbonate can then be subsequently used for capturing CO₂ from a CO₂-containing gas stream.

The source of the CO₂-containing gas comprising water vapor may be of any suitable type, and in addition to ambient air for direct air capture, may for example comprise flue gas from a power generation facility, or flue gas produced by oxidation of a hydrocarbon, or other CO₂-containing gas, which may be a single gas species or a multicomponent gas mixture with which the CO₂ is present. The disclosure also contemplates CO₂ removal from CO₂-containing gases formed as a mixture of atmospheric air and other CO₂-containing gas or gases.

The disclosure in a further aspect relates to a system for removal of CO₂ from a CO₂-containing gas comprising water vapor, the system comprising: a reactor; a source of CO₂-containing gas comprising water vapor, arranged in feed relationship to the reactor; an alkali metal carbonate adsorbent in the reactor; a regeneration assembly arranged to selectively regenerate the alkali metal carbonate adsorbent after CO₂-removal reactions of the alkali metal carbonate adsorbent; and a control assembly arranged to operate the reactor in an operation comprising (a) contacting the CO₂-containing gas comprising water vapor with the alkali metal carbonate adsorbent under conditions causing (i) the water vapor in the CO₂-containing gas comprising water vapor to react with the alkali metal carbonate to form a corresponding alkali metal carbonate hydrate, and (ii) the corresponding alkali metal carbonate hydrate to react with CO₂ in the CO₂-containing gas comprising water vapor to form a corresponding alkali metal sesquicarbonate; and (b) reacting the alkali metal sesquicarbonate under conditions effective to recover CO₂ and to regenerate alkali metal carbonate hydrate adsorbent therefrom, wherein the control assembly actuates the regeneration assembly for such regeneration according to a predetermined operational condition.

The reactor in such system may be of any suitable type, and may for example comprise a fluidized bed reactor, a fixed bed reactor, moving bed conveyor reactor, rotary kiln-type reactor, or any other type or configuration of reactor that is appropriate to the given implementation of the system. The reactor configuration may be designed to enable the CO₂ containing gas comprising water vapor to contact the alkali metal carbonate sorbent during the adsorption step followed by desorption of CO₂ from the alkali metal sesquicarbonate sorbent in a regeneration assembly.

The regeneration assembly in the system may comprise a heater arranged to heat the alkali metal sesquicarbonate to desorb CO₂ from the alkali metal sesquicarbonate and to regenerate alkali metal carbonate hydrate adsorbent therefrom. The heater may be of any suitable type and operate utilizing any suitable heating modalities, including conductive, convective, radiative, electrically resistive, or other modes of operation. The heater may in various embodiments comprise heating tapes or heating layers of adsorbent laminates, and/or heat exchangers of varied types, including concurrent, countercurrent, and crossflow types. In embodiments, the heater may heat the alkali metal sesquicarbonate to a temperature of about 50° C. to 120° C. to recover CO₂ and to regenerate the alkali metal carbonate hydrate adsorbent therefrom.

The regeneration assembly in various embodiments may comprise a vacuum pump arranged to impose vacuum on the alkali metal sesquicarbonate in the reactor to recover CO₂ and to remove contaminants from the CO₂-containing source with water vapor. In other specific embodiments, the regeneration assembly may comprise both heating and vacuum components, e.g., a vacuum pump arranged to impose vacuum on the alkali metal sesquicarbonate in the reactor during heating thereof by the regeneration assembly to recover CO₂ and to regenerate alkali metal carbonate hydrate adsorbent therefrom.

In an exemplary system for removal of CO₂ from a CO₂-containing gas comprising water vapor, the source of CO₂-containing gas comprising water vapor, arranged in feed relationship to the reactor, comprises an atmospheric air intake assembly operating to deliver atmospheric air to the reactor. In the system wherein the CO₂-containing gas comprising water vapor is atmospheric air, the control system may comprise a mechanism for measuring the ratio p_{H2O}/p_{CO2}, of the partial pressure of CO₂, p_{CO2}, to the partial pressure of water vapor, p_{H2O}, in atmospheric air. For example, the ratio p_{H2O}/p_{CO2} in the atmospheric air may be in a range of from 5 to 100 or may be in a range of from 10 to 70. The control system may adjust the operating conditions of the reactor, for instance adsorption step time or regeneration temperature, as a function of p_{H2O}/p_{CO2} to optimize CO₂ recovery. Moreover, the control system may also include a mechanism by which additional water in the form of water vapor can be added to the intake atmospheric air to achieve a desirable ratio p_{H2O}/p_{CO2} in the reactor. For example, a desirable ratio p_{H2O}/p_{CO2} to be achieved in the reactor can be from 10 to 70.

In an alternative embodiment, in the system wherein the CO₂-containing gas comprising water vapor is atmospheric air, the control system may comprise a mechanism for measuring the relative humidity in the atmospheric air being introduced to the reactor. For example, the humidity in the atmospheric air may be in a range of from 5% to 100% or may be in a range of from 20% to 100%. The control system may adjust the operating conditions of the reactor, for instance adsorption step time or regeneration temperature, as a function of relative humidity to optimize CO₂ recovery. Moreover, the control system may also include a mechanism by which additional water in the form of water vapor can be added to the intake atmospheric air to achieve a desirable relative humidity for the air in the reactor. For example, a desirable relative humidity for the air in the reactor may be from 20% to 100%.

In other embodiments, the source of CO₂-containing gas comprising water vapor, arranged in feed relationship to the reactor, may comprise a power generation facility producing the CO₂-containing gas comprising water vapor as effluent flue gas. In still other embodiments, the source of CO₂-containing gas comprising water vapor, arranged in feed relationship to the reactor, may comprise an oxidation or combustion source that produces the CO₂-containing gas comprising water vapor as effluent gas. In various embodiments, the source of CO₂-containing gas comprising water vapor may supply atmospheric air in mixture with a CO₂-containing flue gas or a CO₂-containing effluent gas.

The system of the disclosure may comprise the alkali metal carbonate adsorbent of any suitable composition or form, as variously described hereinabove in respect of the process of the present disclosure. For example, the alkali metal carbonate adsorbent may comprise at least one of sodium carbonate, potassium carbonate, lithium carbonate, and cesium carbonate. In various embodiments of the disclosure, the alkali metal carbonate adsorbent advantageously comprises sodium carbonate. It will be appreciated that the adsorbent utilized in the process and system of the present disclosure may be widely varied in composition and form, and may include various other adjunctive components, including adsorption and/or desorption enhancing dopants, as well as any of various suitable promoters, stabilizers, and other components as appropriate to the specific implementation of the adsorbent in particular processes and systems of the disclosure.

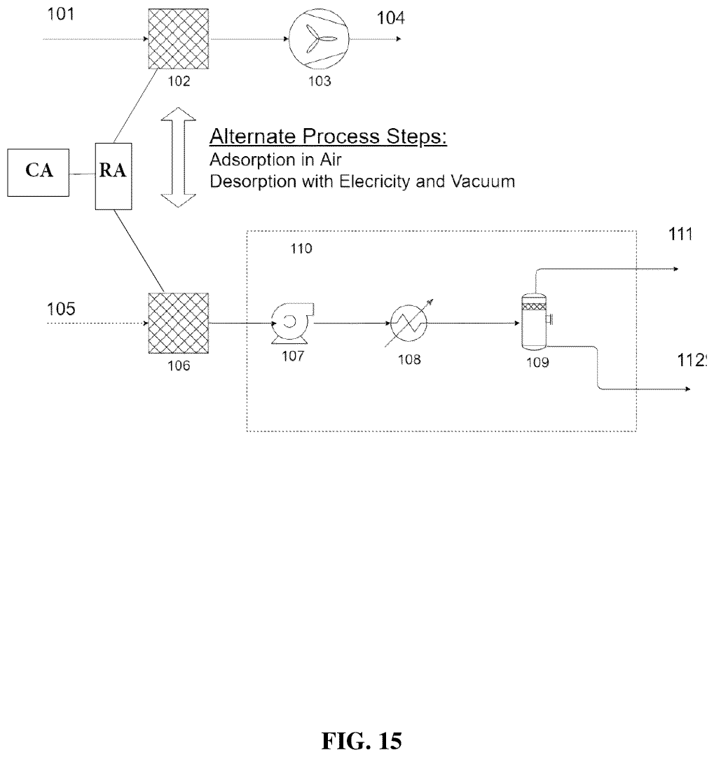

FIG. 15 is a schematic representation of an exemplary embodiment of a process system including cyclically operated adsorbent vessels in which CO₂ is removed from ambient air using alkali metal adsorbent and desorbed with electricity and vacuum. Exemplary embodiments of adsorbent vessels and process systems are described in International Patent Application No. PCT/US22/19564, which is incorporated herein by reference in its entirety.

The process system of FIG. 15 captures CO₂ directly from the atmosphere (DAC) in which a stream of air, 101, is pulled across the adsorption reactor, 102, by a fan, 103, and then vented to the atmosphere, as a CO₂-reduced stream 104. The adsorption reactor 102 comprises a fixed bed reactor vessel containing alkali metal sorbent which is active for CO₂ capture in the fixed bed arrangement. The p_{H2O}/p_{CO2} of the influent air stream 101 is 20, which represents a median point of the average yearly p_{H2O}/p_{CO2} across all 50 states in the United States of America.

The alkali metal sorbent material may be provided in the form of a sodium-based sorbent that has been dispersed onto an alumina support which has been coated onto a ceramic monolith with multiple, parallel flow channels being provided in such structured adsorbent assembly for flow of the CO₂-containing gas for contacting with the alkali metal sorbent material. The multiple, parallel flow channels are provided in suitable numbers and size to ensure very low pressure drop due as a result of low flow velocity of the CO₂-containing gas in the multiple, parallel flow channels, which enables low energy consumption in fan 103.

As air 101 is introduced into the adsorption reactor 102 the sorbent is in a mixed state between both hydrate (Na₂CO₃(s)·H₂O(s)) and carbonate (Na₂CO₃(s)) and first undergoes the hydration reaction (3) with water vapor contained in stream 101

Na₂CO₃(s)+H₂O(g)=Na₂CO₃(s)·H₂O(s) (3),

such that most of the sorbent is in the hydrate state. CO₂ contained in stream 101 is subsequently removed via reaction (4) with the sodium hydrate to form the sodium sesquicarbonate.

3Na₂CO₃·H₂O(s)+CO₂(g)+2H₂O(g)↔2Na₂CO₃·NaHCO₃·2H₂O(s) (4)

Once the sorbent reaches a pre-determined level of saturation, the flow of stream 101 is stopped from entering the adsorption reactor 102 by closing a sealing device such as a louver, door, gate, plate, panel, or similar device at the inlet and outlet of the reactor to prevent air ingress creating regeneration reactor 106, by action of the regeneration assembly RA as actuated by the control assembly CA. Air flow in stream 101 continues for other adsorption reactors 102 which operate in parallel to form a process cycle yielding a continuous product stream of removed CO₂.

Regeneration reactor 106 during the regeneration operation is placed under a slight vacuum by vacuum blower 107 to remove air contaminants such as N₂, O₂, and Ar from the reactor. Then, electricity, denoted as stream 105, is introduced to the regeneration reactor 106 to heat the CO₂ sorbent to 120° C. to release the captured CO₂ and regenerate the sodium sesquicarbonate sorbent back to the sodium carbonate or sodium carbonate hydrate. The electricity can be converted into heat using a resistive heater, induction heater, or the like. The rate or electricity input and temperature output is carefully controlled by control assembly CA to achieve the desired regeneration state of the sorbent. The desorbed CO₂ exits the regeneration reactor 106 through the vacuum blower 107, cooler 108, and condensate knock-out vessel 109, the vacuum blower 107, cooler 108, and condensate knock-out vessel 109 collectively forming the CO₂ collection apparatus 110. From the condensate knock-out vessel 109 of the CO₂ collection apparatus 110, a pure or substantially pure CO₂ overhead stream is discharged in CO₂ effluent line 111, and condensate from the co-produced water is discharged from the condensate knock-out vessel 109 of the CO₂ collection apparatus 110 in water discharge line 112.

In alternative embodiments, a sweep gas of humidified CO₂ is utilized in regeneration reactor 106 in place of or in addition to the vacuum pump 107 to maintain the hydrate state of the alkali metal carbonate sorbent prior to or during the heating through electricity 105.

Accordingly, the process system for CO₂ removal may be operated with a single reactor which is alternatingly and cyclically switched between operation in an adsorbing mode, and operation in a regenerating mode. Alternatively, the process system for CO₂ removal may be operated with multiple reactors, each of which is alternatingly and cyclically switched between operation in an adsorbing mode, and operation in a regenerating or standby mode, so that at least one of the multiple reactors is in adsorption operation at any time during the overall operation of the process system.

The regeneration assembly RA may be arranged in any suitable manner to selectively regenerate the alkali metal carbonate adsorbent after CO₂-removal reactions of the alkali metal carbonate adsorbent, by any appropriate regeneration modality or modalities, including for example regeneration by heat and/or vacuum desorption regeneration.

The control assembly CA may comprise a central processing unit, programmable logic controller, cycle time controller, or any other control components, devices, and apparatus effective for controlling the operation of the process system, so that the control assembly is arranged to operate the reactor in an operation comprising (a) contacting the CO₂-containing gas comprising water vapor with the alkali metal carbonate adsorbent under conditions causing (i) the water vapor in the CO₂-containing gas comprising water vapor to react with the alkali metal carbonate to form a corresponding alkali metal carbonate hydrate, and (ii) the corresponding alkali metal carbonate hydrate to react with CO₂ in the CO₂-containing gas comprising water vapor to form a corresponding alkali metal sesquicarbonate; and (b) reacting the alkali metal sesquicarbonate under conditions effective to recover CO₂ and to regenerate alkali metal carbonate hydrate adsorbent therefrom, wherein the control assembly actuates the regeneration assembly for such regeneration according to a predetermined operational condition.

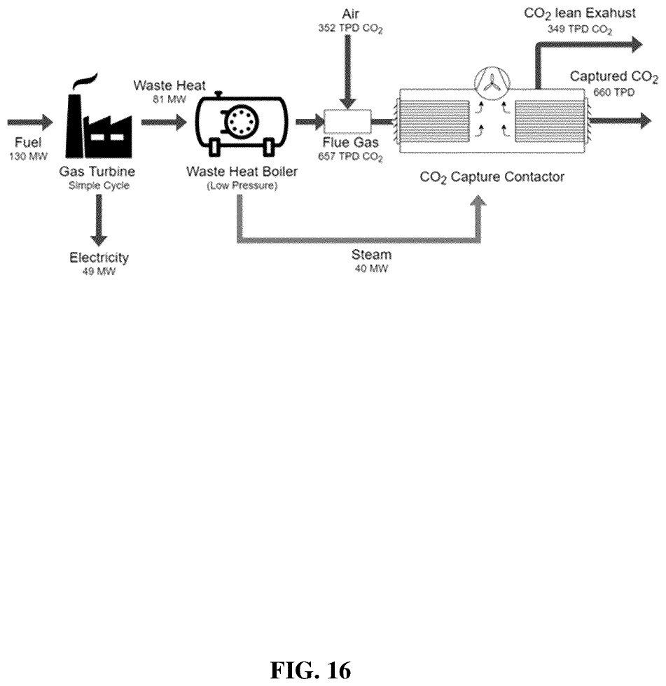

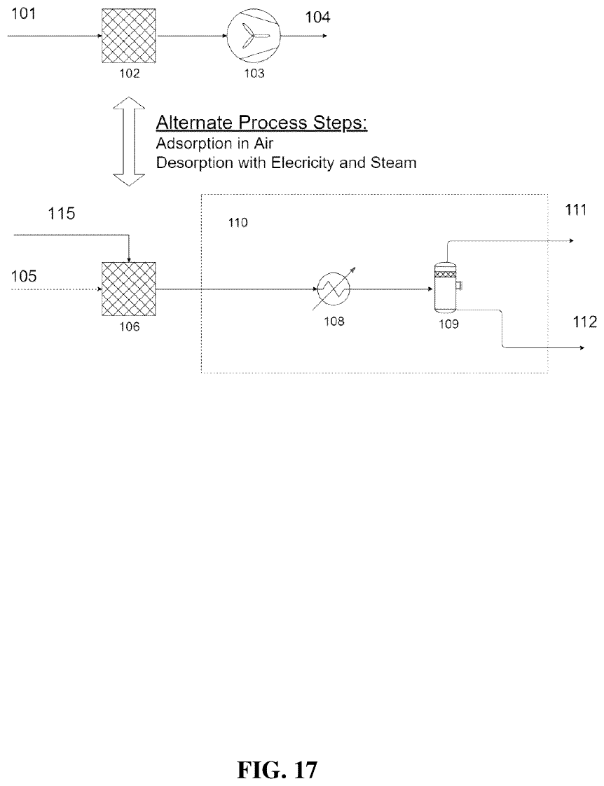

FIGS. 16 and 17 are schematic representations of other embodiments of CO₂ adsorption process systems, wherein CO₂ produced by a natural gas simple cycle (gas turbine only) power plant facility is captured at 100% recovery. FIG. 16 is a schematic representation of a process system in which waste heat from an electricity-generating power plant is utilized in removing CO₂ from flue gas and from ambient air to produce synergistically captured CO₂, in accordance with another embodiment of the present disclosure. FIG. 17 is a schematic representation of a process system including cyclically operated adsorbent vessels in which CO₂ is removed from ambient air, as well as from other CO₂-containing gas, using alkali metal adsorbent and desorbed with electricity and steam.

In an illustrative operation of the systems shown in FIGS. 16 and 17, natural gas fuel with 130 MW heating value generates 49 MW of power (37% efficiency) and 81 MW of waste heat in exhaust flue gas at temperature of 450° C. to 500° C. as shown in FIG. 16. The waste heat from this exhaust gas is sent to a single-pass, low pressure heat recovery steam generator (HRSG), shown in FIG. 16 as waste heat boiler, operating at 2.5 bar to produce steam which subsequently provides most of the energy necessary for regeneration (stream 115, FIG. 17). The exhaust flue gas from the HRSG at 125° C., containing approximately 4 vol % CO₂ and 8 vol % H₂O, with a p_{H2O}/p_{CO2} of 2, is blended with air in an amount that is sufficient to lower the temperature of the air-diluted flue gas stream to a level appropriate for the adsorption reaction without requiring further cooling. Blending the flue gas with air further increases the p_{H2O}/p_{CO2} ratio of the resulting stream 101 to a suitable value, e.g., p_{H2O}/p_{CO2}=23, and the blended flue gas/air stream then is sent to the adsorption reactor (CO₂ Capture Contactor in FIG. 16; fixed bed adsorbent reactor 102 in FIG. 17). The adsorption follows the same steps as described in the preceding exemplary embodiment shown in FIG. 15.

Once the alkali metal carbonate sorbent in the adsorption reactor reaches an appropriate saturation level (of alkali metal sesquicarbonate loading thereon) the adsorption reactor is removed from the mixed flue gas-air stream 101, and is operated as regeneration reactor 106, being regenerated with a combination of steam, in stream 115, and electricity, in stream 105. The electricity is utilized to provide heat at the beginning of the regeneration operation to partially increase the sorbent temperature and then steam is utilized to provide the remainder of the heat as well as to provide a flowing stream in the sorbent bed to remove desorbed CO₂. The resulting steam-CO₂ mixture is cooled, with water being condensed in cooler 108, and then the water is separated from the CO₂ in the condensate knock-out vessel 109 of the CO₂ collection apparatus 110, with a pure or substantially pure CO₂ overhead stream being discharged in CO₂ effluent line 111, and condensate from the co-produced water being discharged from the condensate knock-out vessel 109 in water discharge line 112.

As shown in FIG. 16, captured CO₂ is produced by the process system CO₂ Capture Contactor in the amount of 660 tons CO₂ per day, with a CO₂ lean exhaust of 349 tons CO₂ per day, based on air intake of 352 tons CO₂ per day, and flue gas intake of 657 tons CO₂ per day, in the system in which fuel to the gas turbine facility supplies 130 MW of energy, electricity is produced in an amount of 49 MW, waste heat is generated from the turbine in an amount of 81 MW, and steam is generated requiring 40 MW of energy.

It will be appreciated that the process systems illustratively shown schematically in FIGS. 16 and 17, like the process system shown and described with reference to FIG. 15, may be constructed and operated with regeneration assembly and control assembly components, of any type or types that are appropriate for carrying out the CO₂ removal process in the process system.

The features and advantages of the CO₂ removal process and system of the present disclosure are more fully shown by the following non-limiting examples.

### EXAMPLES

### Example 1

A sorbent sample of 40 wt % Na₂CO₃ supported on silica-alumina was prepared as follows: Sodium bicarbonate (5.30 g) was added to a beaker containing around 100 mL of D. I. H₂O and mixed with a magnetic mixer until a clear solution was obtained. Silica-alumina support powder (5.0 grams) was then gradually added into the above solution while mixing. After the powder was added, mixing continued for 4-12 hours. The water was vaporized by raising the slurry temperature to −75° C. on the hot plate and a paste was formed. Once the paste was formed, it was put into a drying oven at 120° C. for 12 hrs. The dried sample was then transferred into a box furnace and calcined at a temperature in the range 200-400° C. for 2-4 hrs. Upon completion, the furnace was cooled, and the calcined powder was collected and crushed with a mortar and pestle such that the granules had a particle size within a range of 250 to 425 μm and then placed in a sample container for storage.

The supported sorbent granule sample was subjected to adsorption-desorption cycling to determine the effect of water to CO₂ ratio on sorbent capacity. Approximately 0.5 grams of the prepared granules were loaded into a reactor in the vertical orientation with outside diameter of 1 inch. The reactor tube was loaded with support material from bottom to top in the following order—glass wool packing, SiC grit (10 mesh), SiC grit (40 mesh), 0.5 grams of sample mixed with 40 mesh SiC grit, 10 mesh SiC grit, and glass wool packing.

Reactor effluent was passed through gas analyzers where CO₂ and water concentration were measured (ppm level). Total CO₂ adsorbed and desorbed was calculated using the measured values of CO₂ and water concentration. The sample underwent 18 cycles of adsorption/regeneration where the humidity of the air used for the adsorption step was altered after every three cycles.

Prior to cycling, the sample underwent a pretreatment step which consisted of heating to 120° C. and holding for 30 minutes before heating to 200° C. and holding for 120 minutes, all under 100 mL/min of dry N₂ flow. Two streams of certified air (389 ppm by volume of CO₂) from a gas cylinder were used during adsorption with the flow rates controlled by calibrated mass flow controllers. One stream was passed through a water impinger until approximate saturation at room temperature (˜22° C.) whereas the other stream remained dry. They were blended to create different relative humidities (RH) from 0-100% at a combined flowrate of 500 mL/min.

The adsorption step lasted for 60 minutes except for the first cycle which proceeded for 120 minutes. Data from the first cycle are not included in the analysis since it occurred directly after a high temperature pretreatment and hence does not represent working capacity. After adsorption, the reactor was purged for 10 minutes with 200 mL/min of dry nitrogen gas. Desorption was performed under 100 m/min of dry nitrogen. In desorption, the sample was heated to 120° C. where it was held for 30 minutes (except for the first cycle, which continued for 60 minutes) before free cooling back to ambient temperature.

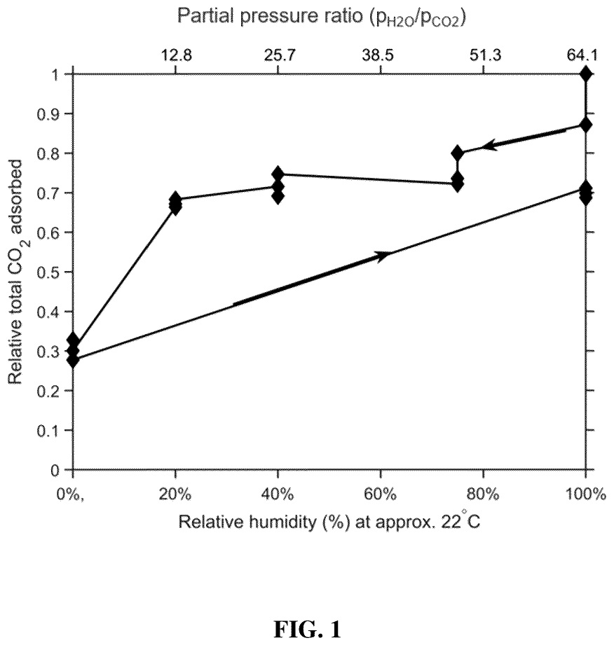

Cycling started with 100% RH air, which was gradually decreased over cycles to 0% RH before finally returning to 100% to check for hysteresis. Table 1 shows relative humidities used for the sample cycling. The results for cumulative CO₂ adsorbed on each cycle as a function of RH are shown in FIG. 1 where the arrows indicate the chronology of the cycles from oldest to most recent. The first cycles were performed at 100% RH and exhibited relatively high CO₂ uptake, exceeding 200 μmol-CO₂/g-sample. As the humidity was reduced to a range of 75%-20%, a slight reduction in CO₂ uptake was seen to ˜160 μmol-CO₂/g-sample. As can be seen in FIG. 1, there was a slight reduction in CO₂ uptake around about 75% RH and then the CO₂ uptake remained relatively constant (i.e., between about 160-170 μmol-CO₂/g-sample) until a RH of about 20%. A sharper change in CO₂ uptake was seen when RH decreased from 20% RH to 0% (dry air). The CO₂ uptake dropped from −160 μmol-CO₂/g-sample to ˜75 μmol-CO₂/g-sample, demonstrating the importance of moisture in air for effective and high CO₂ adsorption, as disclosed herein.

A final series of three cycles were performed at 100% RH. As can be seen in FIG. 1, the CO₂ adsorption capacity drastically increased to ˜165 μmol-CO₂/g-sample. This result represents a slight hysteresis since the initial data at 100% was in the range 200-240 μmol-CO₂/g-sample. However, a drop off in CO₂ uptake over the first few cycles is not unexpected as the sample gradually reaches equilibrium after the initial pre-treatment.

TABLE 1
Relativity humidities for cycles

| | Relative humidity | Ratio H₂O (p_{H2O}) to CO₂ |
|---|---|---|
| Cycles | at 22° C. | (p_{CO2}) partial pressures |
| 1-3 | 100% | 64 |
| 4-6 | 75% | 48 |
| 7-9 | 40% | 26 |
| 10-12 | 20% | 13 |
| 13-15 | 0% | 0 |
| 16-18 | 100% | 64 |

The ratio of H₂O (p_{H2O}) to CO₂ (p_{CO2}) partial pressures were determined for the testing cycle. The measured partial pressure of water (p_{H2O}) at 100% RH (no flow is blended in from the dry air stream) when bypassing the reactor (no adsorption of CO₂ or water) was 0.024 atm (or 24,000 ppmv), which corresponds to a p_{H2O}/p_{CO2} (partial pressure of CO₂) ratio of 64. When RH was reduced to 20% the p_{H2O}/p_{CO2} ratio reduced to 13. For dry air, the ratio is 0. The results shown in FIG. 1 demonstrates that water is essential as a component in air for high CO₂ adsorption by Na₂CO₃ from air. As humidity increases, so too does CO₂ adsorption.

### Example 2

A Malvern PANalytical Empyrean—Linear Detector and Non-ambient Environment X-ray Diffractometer combined with an Anton Paar XRK-900 temperature-controlled stage was used for materials characterization in the range of ambient temperature up to 200° C.

Approximately 0.25 gram of finely ground NaHCO₃ powder (Sigma-Aldrich) was loaded into the gas tight XRK-900 stage on the sample holder on top of a perforated ceramic (Macor) disk/sieve. Gases for dispersing air flow throughout the powder were injected through the perforated disk. The powder was lightly compressed to ensure a flat surface for X-rays. XRD scans were performed over a 20 range of 20-50° in 0.0260 increments with a total scan time of 20 min. Gas analyzers were used to detect the CO₂ levels in the effluent stream to measure the amount of adsorbed and desorbed CO₂ under the different gas flows. Gas flow was controlled by calibrated mass flow controllers (MFCs).

### NaHCO₃ Decomposition

A series of scans were performed to analyze and evaluate NaHCO₃ decomposition. For initial testing, dry nitrogen gas (25-50 mL/min) was flowed through the chamber and the sample was heated at the following temperatures: 25, 60, 80, 100, 120, 150, 200° C. during scanning. For the first scanning series, the sample was held for 10-20 minutes at each temperature before a scan began and was then held at that temperature for the duration of the scan. A second scan was performed at 200° C. at a time 60 minutes after the first series of scanning was completed. The sample was then cooled to 25° C., and after a 60-minute wait, a final scan was performed. Dry nitrogen gas was flowed overnight at 50 mL/min to maintain an inert sample environment.

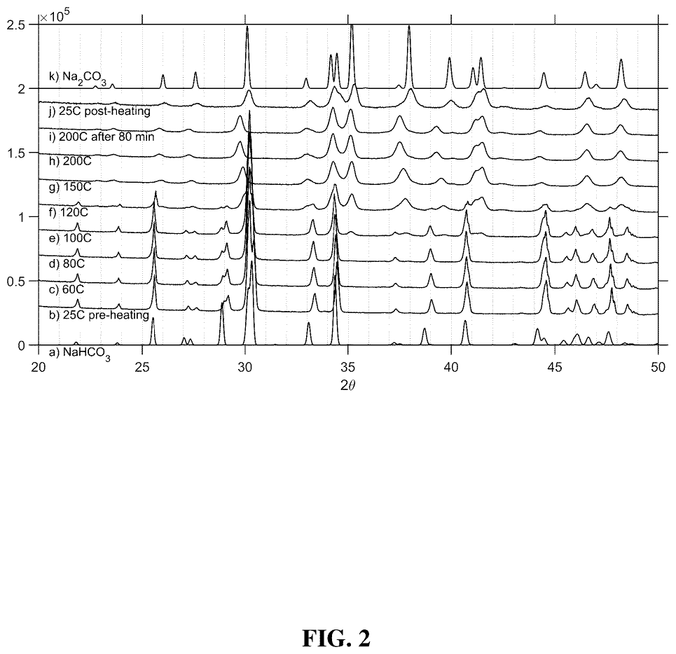

The first series of scans performed at different temperatures are shown in FIG. 2 and are offset for clarity. Reference patterns for NaHCO₃ (a) and Na₂CO₃ (k) are shown for comparison. As can be seen, the XRD patterns from 25° C. (pre-heating) up to 80° C. corresponded with the NaHCO₃ reference pattern well. However, a marked difference in the XRD patterns between 80° C. and 120° C. were seen. Particularly prominent was the emergence of peaks just above the 20 values of 33°, 35°, 38°, 39.5° and 41-42°. The new peaks matched the prominent peaks in the Na₂CO₃ reference pattern. Similarly, peaks at the 20 values of ˜26.5°, 29°, 39°, 40.75° and 44.5° became much weaker above 100° C. The diminishing peaks were associated with NaHCO₃. The patterns show the sample decomposing from NaHCO₃ to Na₂CO₃ as temperature increased from 25° C. to 200° C.

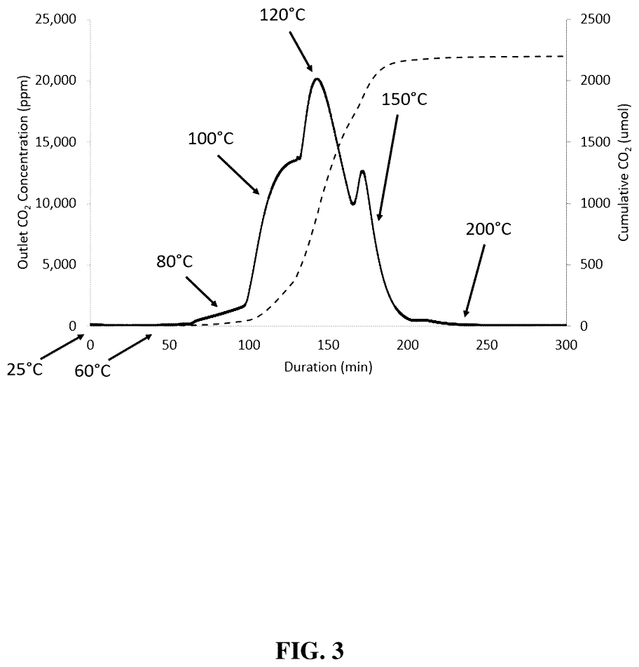

FIG. 3 is a line chart showing the cumulative CO₂ desorbed (light curve) during heating, which was calculated by measuring the CO₂ concentration in the effluent (dark curve) with gas analyzers and selecting the flowrates with the MFCs. Temperatures at various times during heating are shown in FIG. 3. As can be seen, most of the CO₂ desorption occurred between 80-150° C., which corresponds with the temperatures at which relatively large changes in the XRD patterns of the NaHCO₃ powder samples took place.

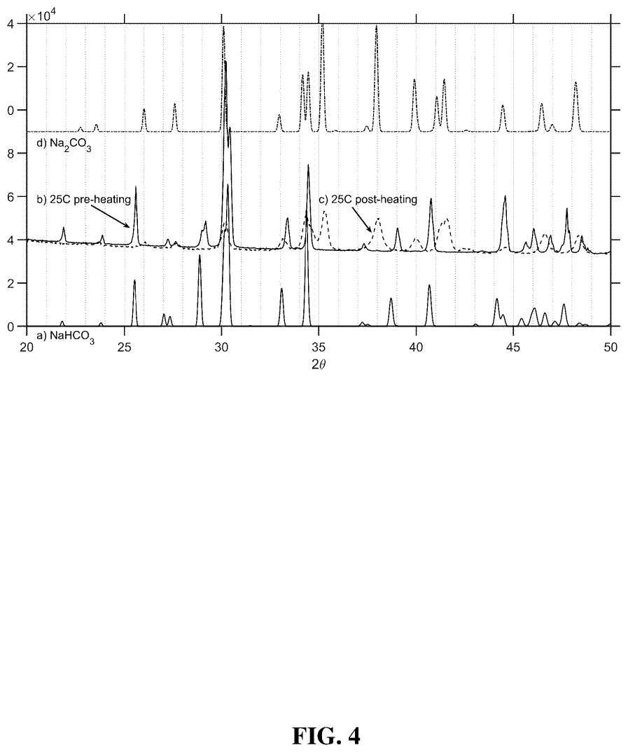

FIG. 4 is a series of XRD scans showing how the NaHCO₃ sample changed after the series of heating cycles described above. Reference patterns for NaHCO₃ (a) and Na₂CO₃ (d) are shown for comparison. Both scans of the sample were performed at 25° C. but curve (b) was a NaHCO₃ sample prior to the heating series (pre-heating sample) and curve (c) was measured from the sample after the heating series wherein the sample was heated to 200° C. and then cooled back to 25° C. (post-heating). Comparing the sample scans to reference scans for Na₂CO₃ and NaHCO₃ shows that the pre-heating sample pattern matches the NaHCO₃ reference scan while the post-heating sample scan more closely matches the reference scan for Na₂CO₃.

### Na₂CO₃ Adsorption

Adsorption was performed at room temperature on the same sample that had been heated to decompose NaHCO₃ into Na₂CO₃. Prior to adsorption testing, the sample was held under nitrogen flow to maintain an inert atmosphere. Two streams of certified air (390.5 ppmv of CO₂) from a gas cylinder were used during adsorption with the flow rates controlled by mass flow controllers. One stream was passed through a water impinger until saturation at room temperature whereas the other stream remained dry. The streams were blended in a ratio to create a 75% relative humidity certified air stream. The total flowrate was 100 mL/min of the 75% RH stream for the first 30 minutes of adsorption and 150 m/min thereafter. An XRD scan was performed immediately prior to starting the air flow. The adsorption phase lasted 1340 minutes with continuous back-to-back 20 min XRD scans being performed. An additional room temperature XRD scan was collected on a fine powder (˜0.25 g) of Na₂CO₃·H₂O as a reference.

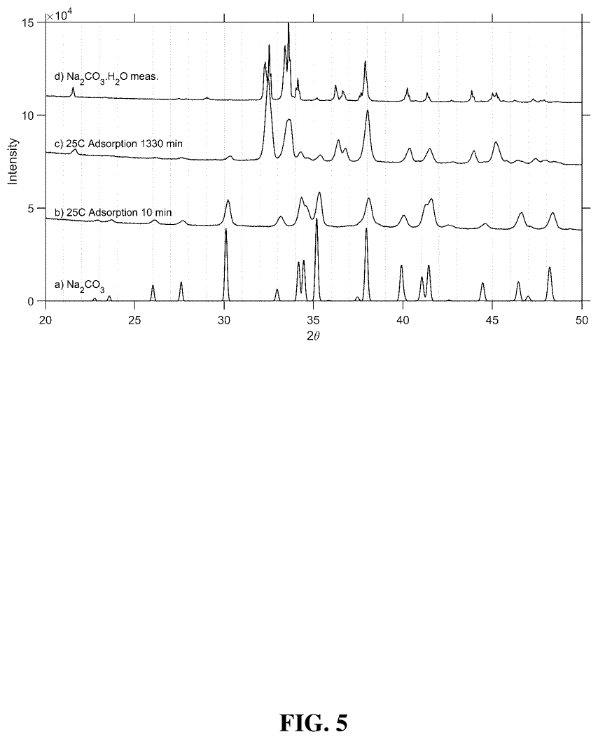

FIG. 5 is a series of XRD scans showing the first (b) and last (c) XRD scan taken during the room temperature adsorption phase. Reference scans for Na₂CO₃ (bottom) and Na₂CO₃·H₂O (top) are shown for comparison. The XRD scan at 10 minutes shows that at the beginning of adsorption the measured data corresponded more closely with the anhydrous Na₂CO₃ reference pattern. However, the XRD scan after 1330 minutes of adsorption reaction time had many peaks matching the reference Na₂CO₃·H₂O (Sigma-Aldrich) pattern. In particular, after adsorption, strong new peaks at 20 values of ˜21.5°, 32.5°. 33.5°, 36-37°, 440 and 45.25° were seen, corresponding to peaks in the Na₂CO₃·H₂O XRD reference pattern. As can be seen in FIG. 5, in the presence of humid air at ambient temperature, Na₂CO₃ firstly converts to Na₂CO₃·H₂O.

### Example 3

### Pre-XRD-Treatment

Prior to in-situ XRD measurements the samples underwent adsorption/desorption cycles in a small reactor where the amount of CO₂ adsorbed and desorbed was calculated by measuring the CO₂ concentration in the effluent stream. Samples consisted of Na₂CO₃ dispersed on an alumina support. Synthesis was similar to that described in Example 1 except in these samples 30 wt % Na₂CO₃ was dispersed on alumina. Approximately 0.4 grams of the samples (250-425 micron particle size granules) were used during initial cycling.

All samples underwent a common pretreatment and first cycle, but the adsorption time for the second cycle was varied. After the 2^{nd} adsorption cycle ended, the samples were removed and stored for later XRD analysis. Pretreatment consisted of heating to 120° C. and holding for 30 minutes before heating to 200° C. and holding for 120 minutes, all under 100 m/min of N₂ flow. The first adsorption step for all samples was common and involved flowing 500 m/min of certified (391 ppmv of CO₂) air, which was fully humidified (saturated) by passing through a water impinger. After adsorption, the reactor was purged for 10 minutes with 200 m/min of dry nitrogen. Desorption was performed under 100 m/min of dry nitrogen and the sample was heated to 120° C. where it was held for 1 hour before free cooling back to ambient temperature.

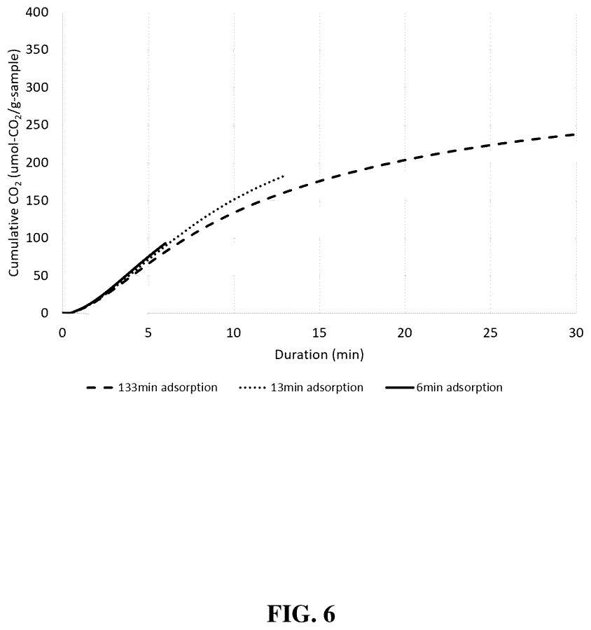

The final step was a second adsorption, the duration of which was varied to achieve different CO₂ adsorption amounts on the samples. Sample 1 adsorbed for 133 minutes, sample 2 for 13 minutes and sample 3 for 6 minutes, which gave CO₂ loadings of 120.0, 73.8 and 35.9 μmol/g-sample, respectively. The cumulative CO₂ adsorbed for the three samples is shown in FIG. 6 as a function of time. After this step, the samples were stored in sealed vials for the XRD treatment.

### Adsorption

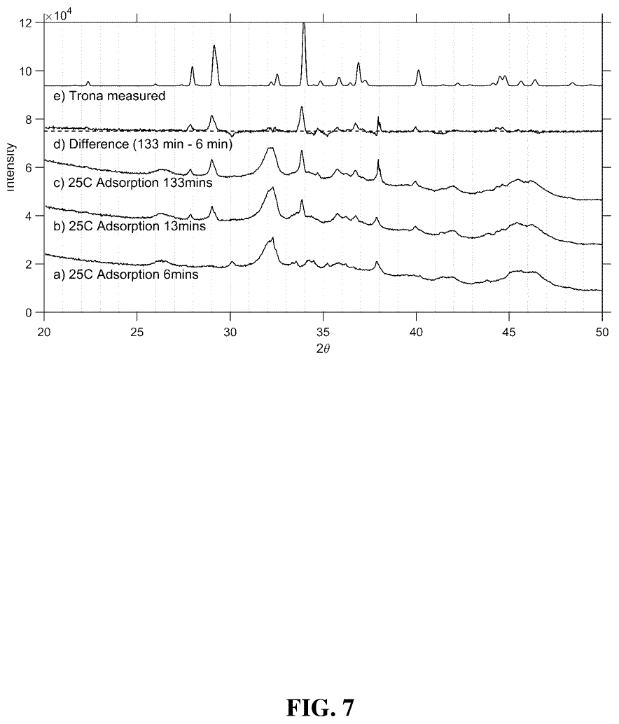

Approximately 0.25 gram of samples 1, 2 and 3 were used for XRD measurements. The 250-425 micron particle size granules were ground into fine powders and were used for all XRD measurements. Powders were lightly compressed to ensure a flat surface for X-rays. Different tests were performed where the samples were loaded into the XRK-900 stage. The results of room temperature XRD scans are shown in FIG. 7 for samples 1 (c), 2 (b) and 3 (a). Scans were performed over 20 values of 20-50° in 0.0260 increments with a total scan time of 60 minutes. Gas flow was controlled by calibrated mass flow controllers. The difference in intensities between sample 1 (133 minutes adsorption) and sample 3 (6 minutes adsorption) is shown as the dark curve (“d) Difference”). For the difference curve, the intensities have been magnified by 3× for clarity. An additional 20-minute room temperature XRD scan was performed on fine powders (˜0.25 gms) of sodium sesquicarbonate dihydrate (Na₂CO₃·NaHCO₃·2H₂O), which is also referred to herein as Trona (Solvay T-50) with no gas flow, as a reference curve for comparison. The Trona XRD scan is the top curve. As can be seen, the difference curve and Trona curve are remarkably similar with nearly all major peaks matching. This result indicates that during CO₂ adsorption Trona (sodium sesquicarbonate dihydrate) is formed.

### Desorption

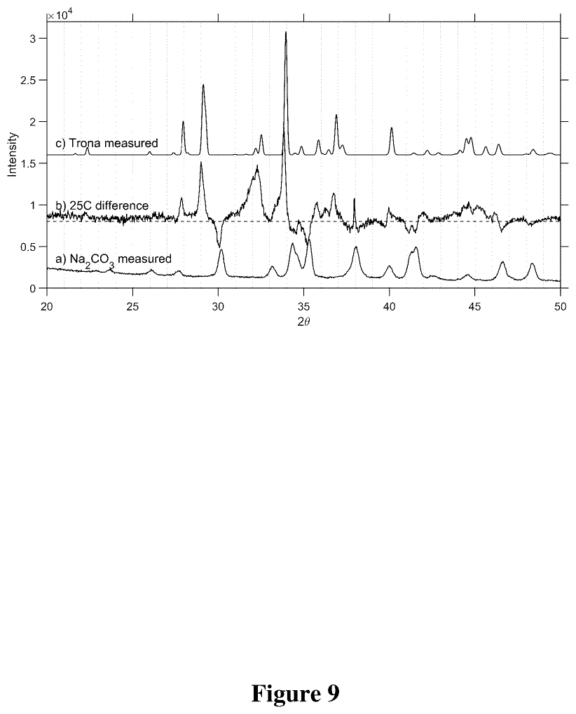

Sample 1, which had previously undergone a long adsorption and hence high CO₂ pickup, was loaded, and sealed in the XRK-900 stage. The powder was positioned on the sample holder on top of a perforated ceramic (Macor) disk/sieve. Dry nitrogen (50 mL/min) was injected from below through the perforated disk which functioned to disperse gas flow throughout the powder. This flow removed any gases produced during desorption. The testing involved heating the sample while scanning at the following temperatures: 25, 60, 80, 100, 120, 150, 200° C. The sample was held for 10-20 minutes at a temperature before beginning a XRD scan and held at that temperature for the duration of the scan. The sample was then cooled to 25° C., and after a 60-minute wait, a final scan was performed. The scans are shown in FIG. 8 and offset for clarity. Additionally, the bottom curve in FIG. 8 represents the intensity of the initial XRD pattern at 25° C. before heating minus the intensity of the XRD pattern after heating to 200° C. and cooling to 25° C. (“a) 25° C. Difference”). FIG. 9 is a series of XRD scans showing a comparison of the difference curve to the experimentally measured referenced XRD patterns for Trona (“c) Trona”) and Na₂CO₃ (bottom, “a) Na₂CO₃”). The XRD data for Na₂CO₃ were obtained by heating and decomposing the NaHCO₃ as described in Example 2. The positive data in the difference curve correspond to peaks present only before heating and the negative peaks correspond to peaks that appear after heating/desorption. As can be seen in FIG. 9, the positive peaks of the difference curve correspond to the Trona pattern, indicating that Trona was present at 25° C. but decomposed upon heating. Conversely, the negative peaks of the difference curve correspond to Na₂CO₃ thus demonstrating that Trona decomposed to Na₂CO₃ under dry nitrogen flow whilst heating. In FIG. 8, a change in XRD pattern in comparison to the difference curve at the bottom is seen between 25 and 60° C., indicating that the adsorbed species Trona decomposes the sorbent at a temperature below 60° C.

### Example 4

A Malvern PANalytical Empyrean—Linear Detector and Non-ambient Environment X-ray Diffractometer combined with an Anton Paar XRK-900 temperature-controlled stage was used for materials characterization in the range of ambient temperature up to 200° C.

Approximately 0.25 gram of finely ground KHCO₃ powder (Sigma-Aldrich) was loaded into the gas tight XRK-900 stage on the sample holder on top of a perforated ceramic (Macor) disk/sieve. Gases for dispersing air flow through the sample were injected from below through the perforated disk. The powder was lightly compressed to ensure a flat surface for X-rays. XRD scans were performed over a 20 range of 20-50° in 0.026° increments with a total scan time of 20 min. Gas flow was controlled by calibrated mass flow controllers.

### KHCO₃ Decomposition

A series of scans were performed to analyze and evaluate KHCO₃ decomposition. For initial testing, dry nitrogen gas (50 mL/min) was flowed through the chamber and the sample was heated to the following temperatures: 25, 60, 80, 100, 120, 150, 200° C. during scanning. For the first scanning series, the sample was held for 10-20 minutes at a given temperature before a scan began and was then held at that temperature for the duration of the scan. The sample was held for a total of 100 minutes at 200° C. before cooling back to 25° C., and after a 60-minute wait, a final scan was performed. Dry nitrogen gas was flowed overnight at 50 mL/min to maintain an inert sample environment.

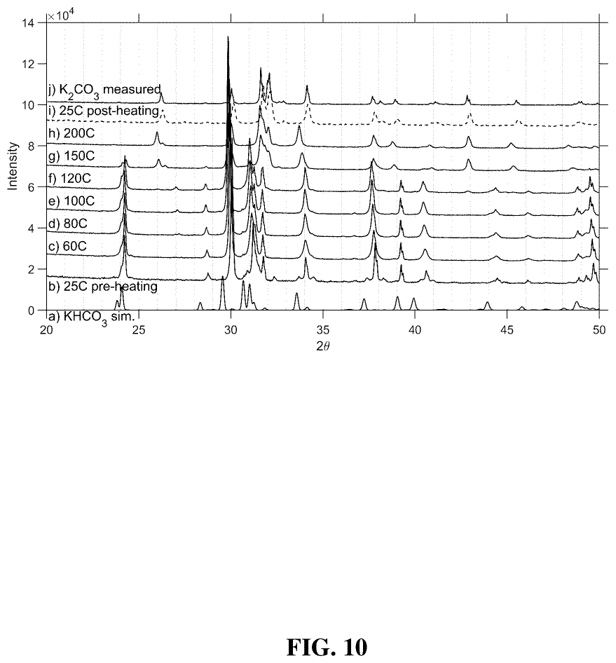

The first series of scans performed at different temperatures are shown in FIG. 10 and are offset for clarity. A reference pattern for KHCO₃ (a) is included which comes from simulations (not experiments) which means that the peak positions can be slightly off due to the inability of calculations to accurately reproduce binding forces. An additional room temperature XRD scan was collected on a fine powder (˜0.25 gram) of K₂CO₃ (Sigma-Aldrich) to use as a reference. It is evident that patterns from 25° C. (pre-heating, b) up to 120° C. (f) match the KHCO₃ reference pattern (a) very well. There is a marked difference in the patterns between 120° C. (f) and 150° C. (g), particularly prominent is the emergence of peaks around 26°, 32°, 39°, 43°, 45.5°. These new peaks match the prominent peaks in the measured K₂CO₃ pattern (j). Conversely, we see peaks at ˜24°, 28.75°, 31°, 39.25°, 40.5° and 49-50° all get much weaker above 120° C. These peaks are associated with KHCO₃. The patterns show the sample decomposing from KHCO₃ to K₂CO₃.

### Adsorption

Adsorption was performed at room temperature on the same sample that had been heated to decompose KHCO₃ into K₂CO₃. Prior to adsorption testing, the sample was held under nitrogen flow to maintain an inert atmosphere. Two streams of certified air (390.5 ppmv of CO₂) from a gas cylinder were used during adsorption with the flow rates controlled by mass flow controllers. One stream was passed through a water impinger until saturation at room temperature whereas the other stream remained dry. The streams were blended in a ratio to create a 75% relative humidity certified air stream. The total flowrate was 100 mL/min of the 75% RH stream for the first 30 minutes of adsorption and 150 mL/min thereafter. A scan was performed immediately prior to starting the air flow. The adsorption phase lasted 320 minutes with XRD scans (each of which took 20 minutes) being performed every 30 minutes.

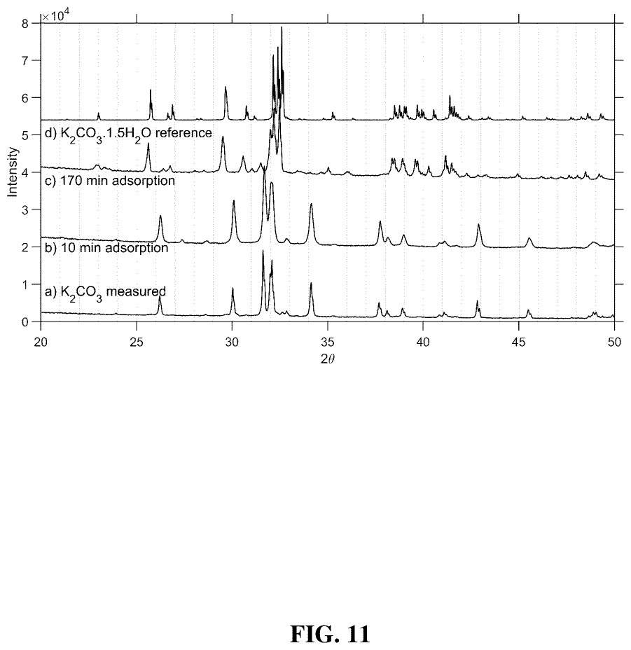

FIG. 11 shows the first (b) scan taken during the adsorption stage and another taken after 170 minutes (c). Initially (scan b) the measured data matches the anhydrous K₂CO₃ pattern (a) very well. However, the pattern after 170 minutes matches the reference K₂CO₃·1.5H₂O pattern. In particular, after adsorption strong new peaks at ˜25.5°, 29.5°. 30.5°, 32-33° are seen, and a collection of peaks in the range 38-42°, which all correspond to peaks in the K₂CO₃·1.5H₂O reference pattern. As can be seen, in the presence of humid air K₂CO₃ firstly converts into K₂CO₃·1.5H₂O.

Accordingly, while the disclosure has been set forth herein in reference to specific aspects, features, and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications, and alternative embodiments, within its spirit and scope.

1. A process for removal of CO₂ from a CO₂-containing gas comprising water vapor, the process comprising:
a) contacting the CO₂-containing gas comprising water vapor with an alkali metal carbonate adsorbent under conditions causing
i. the water vapor in the CO₂-containing gas comprising water vapor to react with the alkali metal carbonate to form a corresponding alkali metal carbonate hydrate, and
ii. the corresponding alkali metal carbonate hydrate to react with CO₂ in the CO₂-containing gas comprising water vapor to form a corresponding alkali metal sesquicarbonate; and
b) reacting the corresponding alkali metal sesquicarbonate under conditions effective to recover CO₂ and to regenerate alkali metal carbonate hydrate adsorbent therefrom.

2. The process of claim 1, wherein, in the CO₂-containing gas comprising water vapor, the ratio p_{H2O}/p_{CO2}, of the partial pressure of CO₂, p_{CO2}, to the partial pressure of water vapor, p_{H2O}, in corresponding units of partial pressure, is in a range of from 5 to 100.

3-5. (canceled)

6. The process of claim 1, wherein the CO₂-containing gas comprising water vapor has a relative humidity in a range of from 0.5% to 100%.

7-8. (canceled)

9. The process of claim 1, conducted for direct air capture of CO₂.

10. The process of claim 1, wherein the CO₂-containing gas comprising water vapor is atmospheric air at ambient temperature.

11. (canceled)

12. The process of claim 1, wherein the conditions in the contacting (a) comprise temperature in a range of from 5° C. to 50° C.

13-14. (canceled)

15. The process of claim 1, wherein the alkali metal carbonate adsorbent comprises at least one of sodium carbonate, potassium carbonate, lithium carbonate, and cesium carbonate.

16-19. (canceled)

20. The process of claim 1, wherein the reaction of the water vapor in the CO₂-containing gas comprising water vapor with the alkali metal carbonate to form the corresponding alkali metal carbonate hydrate in the contacting (a) comprises reaction (3):
Na₂CO₃(s)+H2O(g)=Na₂CO₃(s)·H₂O(s) (3).

21-22. (canceled)

23. The process of claim 1, wherein the alkali metal carbonate adsorbent comprises potassium carbonate, wherein the contacting (a) causes the following reactions (6) and (7):
K₂CO₃(s)+1.5H₂O(g)=K₂CO₃(s)·1.5H₂O(s) (6); and
2K₂CO₃·1.5H₂O(s)+CO₂(g)↔K₂CO₃·2KHCO₃·1.5H₂O(s)+0.5H₂O(g) (7).

24-25. (canceled)

26. The process of claim 1, wherein the alkali metal carbonate adsorbent is supported on a support.

27-32. (canceled)

33. The process of claim 1, wherein the alkali metal sesquicarbonate is reacted by heating thereof to recover CO₂ and to regenerate alkali metal carbonate hydrate adsorbent therefrom, wherein the heating is carried out by steam contacting, hot CO₂ contacting, and/or electrical heating.

34. (canceled)

35. The process of claim 1, wherein the alkali metal carbonate hydrate adsorbent is regenerated from the alkali metal sesquicarbonate by heating of the alkali metal sesquicarbonate under vacuum conditions.

36-37. (canceled)

38. The process of claim 1, wherein the CO₂-containing gas comprises atmospheric air in a mixture with another CO₂-containing gas.

39-40. (canceled)

41. A system for removal of CO₂ from a CO₂-containing gas comprising water vapor, the system comprising:
a reactor;
a source of CO₂-containing gas comprising water vapor, arranged in feed relationship to the reactor;
an alkali metal carbonate adsorbent in the reactor;
a regeneration assembly arranged to selectively regenerate the alkali metal carbonate adsorbent after CO₂-removal reactions of the alkali metal carbonate adsorbent; and
a control assembly arranged to operate the reactor in an operation comprising (a) contacting the CO₂-containing gas comprising water vapor with the alkali metal carbonate adsorbent under conditions causing (i) the water vapor in the CO₂-containing gas comprising water vapor to react with the alkali metal carbonate to form a corresponding alkali metal carbonate hydrate, and (ii) the corresponding alkali metal carbonate hydrate to react with CO₂ in the CO₂-containing gas comprising water vapor to form a corresponding alkali metal sesquicarbonate; and (b) reacting the alkali metal sesquicarbonate under conditions effective to recover CO₂ and to regenerate alkali metal carbonate hydrate adsorbent therefrom, wherein the control assembly actuates the regeneration assembly for such regeneration according to a predetermined operational condition.

42. The system according to claim 41, wherein the regeneration assembly comprises a heater arranged to heat the alkali metal sesquicarbonate to recover CO₂ and to regenerate the alkali metal carbonate hydrate adsorbent therefrom.

43. (canceled)

44. The system according to claim 41, wherein the regeneration assembly comprises a vacuum pump arranged to impose vacuum on the alkali metal sesquicarbonate in the reactor to recover CO₂ and to regenerate the alkali metal carbonate hydrate adsorbent therefrom.

45. The system according to claim 41, wherein the regeneration assembly further comprises a vacuum pump arranged to impose vacuum on the alkali metal sesquicarbonate in the reactor during heating thereof by the regeneration assembly to recover CO₂ and to regenerate the alkali metal carbonate hydrate adsorbent therefrom.

46. The system according to claim 41, wherein the source of CO₂-containing gas comprising water vapor, arranged in feed relationship to the reactor comprises an atmospheric air intake assembly operating to deliver atmospheric air to the reactor.

47-49. (canceled)

50. The system of claim 46, wherein the control system comprises a mechanism for measuring the relative humidity in the CO₂-containing gas comprising water vapor.

51-62. (canceled)

63. The system of claim 41, wherein the reactor is one of multiple reactors, each of which is correspondingly constituted and arranged for operation in a repetitive cyclic sequence of contacting (a) and regeneration of the alkali metal carbonate hydrate adsorbent (b), with at least one reactor carrying out the contacting while at least one other reactor is undergoing regeneration of the alkali metal carbonate adsorbent or is in standby mode after regeneration, awaiting resumption of contacting operation.
